(19) United States
(12) Patent Application Publication
(10) Pub. No.: US 2014/0286016 A1
(43) Pub. Date: Sep. 25, 2014

(54) Luminaire obliquely oriented

(71) Applicant: Louis-Xavier Marie Montagne, Lyon (FR)

(72) Inventor: Louis-Xavier Marie Montagne, Lyon (FR)

(73) Assignee: KONINKLIJKE PHILIPS N.V., EINDHOVEN (NL)

(21) Appl. No.: 14/241,178

(22) PCT Filed: Sep. 3, 2012
(86) PCT No.: PCT/IB12/54542

§ 371 Date: Feb. 26, 2014

(30) Foreign Application Priority Data
Sep. 6, 2011 (EP) 11306104.8

(51) Int. Cl. F21V 7/04; F21V 7/08

(52) U.S. Cl. CPC F21V 7/04; F21V 7/08
USPC 362/296.06; 362/296.07

(57) ABSTRACT

The invention relates to a luminaire arranged to illuminate a surface comprising:

a light source emitting light rays;

a reflective device comprising:
a main reflective member arranged to redirect the light rays, according to a primary light beam, for illuminating a main area of the surface, the light rays being obliquely oriented with respect to the surface, an edge of the main area defining accordingly a curve having an apex, and a referential line not crossing the curve and being separated from the apex by a determined distance is defined;
secondary reflective concave elements designed and arranged with respect to the main reflective member so as to illuminate, according to respective secondary light beams, respective secondary areas located between the curve and the referential line.

The invention also relates to an optical accessory.

### FIELD OF THE INVENTION

The invention relates to a luminaire arranged to illuminate a surface, this luminaire comprising:

a light source;

a reflector designed and oriented to redirect the light rays for illuminating a main area of the surface such that the light rays are obliquely oriented with respect to the surface.

Such a luminaire, obliquely oriented, may be used as a downlight, for example as a wall washer i.e. the surface to be illuminated being a wall.

### BACKGROUND OF THE INVENTION

Said known reflectors are parabolic, hemispherical, conical, and are placed obliquely and close to the surface (to be illuminated) in order to avoid any disturbance in the optical path and to be less cumbersome. Due to the oblique orientation of the light rays, the intersection of the light rays coming from the luminaire and the surface to be illuminated gives an illuminated surface larger at the bottom (if the luminaire is positioned close to the top part of the surface) than at the top part of the surface: the edge of the top portion of said illuminated surface defines a curve having an apex, this curve corresponding to the light cut-off of an edge of the luminaire.

This non-uniform illumination may be not desirable, especially if a large element (e.g. shelves on a wall surface) needs to be illuminated at said top part of the surface.

### SUMMARY OF THE INVENTION

An object of the invention is to increase the uniformity of illumination on the surface to illuminate.

Another object of the invention is to increase the uniformity of illumination within the illuminated portion corresponding to the light cut-off, especially to have a greater or smoother separation between the illuminated and the non-illuminated areas.

Another object of the invention is to obtain an illuminated main area having a flatter shape (i.e. less curved shape) at the light cut-off, while keeping an obliquely oriented reflector.

The invention attempts to fulfill these objects by proposing a luminaire according to claim 1.

It is to be noticed that the “distance” mentioned in claim 1 may be zero or greater.

The invention proposes to adapt the reflector itself, or to add an accessory to it, to re-orientate part of the light coming from the source according to secondary light beams dedicated to increase the illumination of the surface close to said curve.

In other words, the invention allows to increase the illumination of a zone, via secondary areas or light spots, adjacent to the curved edge of the main area but limited by a predetermined line.

In particular the illuminated portion located close to said apex is broadened by the presence of secondary light areas or spots adjacent to said curve and resulting from the secondary light beams, and the curve is accordingly offset and/or flattened if said referential line is straight.

Especially a more squared illuminated surface can be obtained.

Moreover, these secondary light beams allow to fully illuminate a portion of the surface which would have been, without these secondary light beams, illuminated by a curved light halo (i.e. having a light intensity significantly lower than those of said main are and corresponding to a light cut-off effect) located outside said main area and adjacent to said curve. This light halo is a non-desirable lighting effect, since it does not give a clear and neat separation between the illuminated and the non-illuminated surface. Invention allows to remove or decrease the light halo from the surface, and therefore increase the quality of the illumination provided by the luminaire.

The invention gives therefore a better lighting effect and a more efficient use of the light energy.

Optionally, the luminaire is according to claim 2.

Therefore the invention allows to obtain a flattened, more squared and/or broader edge of said main area, allowing to illuminate on the surface some greater area at the limit of the main area, giving better lighting effects and a more efficient use of the light.

Optionally, the luminaire is according to claim 3.

This symmetrical arrangement allows to obtain a symmetrical illumination, via the secondary light beams, with respect to said plane, of the zone defined between said curve and said referential line. This option is particularly useful if the main area is also symmetrical with respect to said plane, because the final resulting illuminated surface remains symmetrical accordingly.

Optionally, the luminaire is according to claim 4.

The reflective elements can therefore be manufactured integrally, in one piece.

Moreover, the adjacency of the sectors may be useful to generate overlapping of the edges of some secondary light beams such that the final illumination of the zone, defined between said curve and said referential line, is more uniform.

Optionally, the luminaire is according to claim 5.

The equation of this function and the level on the secondary reflective elements at which this “cutting” function is applied, may be chosen so as to enlarge more or less the width of the secondary light beams, and therefore the size of the corresponding secondary areas to be illuminated and their respective positions on the surface. This cutting function may in particular allows to distribute the light flux on the bottom or top part of the surface to illuminate. A function is also easy to implement in the design and production phase of the luminaire.

Optionally, the luminaire is according to claim 6.

This configuration optimizes the use and the guiding of the light of secondary light beams and prevents from back reflections to the light source.

In the particular case of one of the reflective elements is a reflective concave ellipsoidal sector (as recited in claim 8), the first focus and the second focus of this ellipsoid are preferably both located on the secondary axis. In particular it may make sense to locate the first focus at the light source, and to have a plurality of those ellipsoidal sections rotatably disposed around the light source (i.e. first focus) so as to guide the secondary beams directly from the light source to the secondary areas to be illuminated.

Optionally, the luminaire is according to claim 7.

Ellipsoid is close to the shape of a light beam, and would avoid therefore back-optical reflection to the light source as much as possible.

Moreover ellipsoid is a specific quadratic shape, easy to parameter.

Nevertheless, other types of shapes of secondary reflective elements may be designed by the person skilled in the art, using well-known methods of design, based for example on optical calculations or modeling for specific primary reflectors, so as to obtain said secondary light beams which illuminate a zone extending between said curve and said referential line. One person skilled in the art may design for instance other shape of secondary elements based on a cylinder, a cone or polynomial of order n.

Optionally, the luminaire is according to claim 9.

This symmetrical arrangement allows to obtain a symmetrical illumination, via the secondary light beams, with respect to said plane, of the zone defined between said curve and said referential line. This option is particularly useful if the main area is also symmetrical with respect to said plane, because the final resulting illuminated surface remains symmetrical accordingly.

In case the number of ellipsoids is odd, the secondary reflective elements comprises a central ellipsoid (the plane of symmetry passing at the center of this central ellipsoid) and lateral ellipsoids located symmetrically at either sides of the central ellipsoid.

In case the number of ellipsoids is even, the secondary reflective elements are lateral ellipsoids located symmetrically at either sides of the plane.

In both cases, the number of ellipsoids, or more generally the number of secondary reflective elements, is adapted depending on the degree of the quality of illumination that is required. Usually, more number of ellipsoids more the zone between said curve and said referential line is homogenously illuminated, with a light intensity close to those of the main area, and with a separation between the illuminated and the non-illuminated surface which is smoothen or neat. So the person skilled in the art will try to find a compromise between the complexity (and costs) of the secondary reflective elements and the quality of the resulting illumination.

Optionally, the luminaire is according to claim 10.

This embodiment allows to manufacture the secondary reflective elements as an accessory, and independently from the main reflective member, which may give more flexibility in the design of this accessory.

Furthermore, several different accessories may be used with the same main reflective member, giving different possible illumination effects. One can imagine replace a first accessory having a first optical configuration by a second accessory having a second optical configuration, and therefore change the illumination effects, while keeping the same luminaire, and without necessarily displacing or retuning the luminaire.

Optionally, the luminaire is according to claim 11.

This embodiment allows to manufacture the secondary reflective elements together with the main reflective member, which may decrease the manufacturing costs of the overall reflective device.

Optionally, the luminaire is according to claim 12. Typically, the light curvature visible at the edge of the illuminated surface (“main area”), obtained due to the light cut-off of the reflective device, is more important if this edge corresponds to the light cut-off of a side of the reflective device close to the surface than if this edge corresponds to the light cut-off of a side of the reflective device remote from the surface.

Therefore it may make sense to provide the secondary reflective elements on the side of the reflective device close to the surface, in order to decrease this more important curvature.

Optionally, the luminaire is according to claim 13.

According to a second embodiment, the invention proposes an optical accessory according to claim 14 or 15.

According to a third embodiment, the invention proposes the use of said luminaire, as a wall washer, said surface being a wall.

### BRIEF DESCRIPTION OF THE DRAWINGS

Other features and advantages of the invention appear from the following detailed description of one of its embodiments, given by way of non-limiting example, and with reference to the following drawings:

FIG. 1 shows a simplified side view of a wall washer system.

FIG. 2 shows a simulation of the top part of a wall illuminated by the wall washer system of FIG. 1.

FIG. 3 shows a secondary optical device according to the invention.

FIG. 4A and 4B show respectively a bottom perspective view and a bottom view of the reflective device of a luminaire comprising a main reflective member and the secondary optical device of FIG. 3.

FIG. 5A, 5B, 5C, 5D, 5E show bottom respective views of the luminaire of

FIG. 4A-4B, with the directions of the secondary and primary light beams emitted by this luminaire.

FIG. 6A, 6B and 6C show schematically, for a luminaire according to the invention (having 8 ellispoidal sections), the theoretical secondary light beams (cones of lights) on FIG. 6A and the illumination effects on the surface (FIG. 6B and 6C).

FIGS. 7 and 8 is two simulations of a resulting wall illumination using the luminaire of FIG. 4A and 4B respectively without and with a secondary optical device according to the invention.

### DETAILED DESCRIPTION OF THE INVENTION

FIG. 1 shows a general lighting system in operation comprising:

a surface 2 to be illuminated (in this case a wall);
a luminaire 1 obliquely oriented with respect to the surface 2 so as to illuminate a major part of the surface 2. This luminaire comprises a light source (e.g. incandescent lamp, fluorescent lamp, discharge lamp, and/or light-emitting diode(s) (<<LED(s)>>)) and a reflective device having an optically reflective inner surface in order to shape the light beam 3 and direct it to the surface 2.

The light beam 3 has a beam angle determined by the shape of said reflective member, and especially by the edge 13 of the reflective member. Indeed this edge 13 acts as a light cut-off and determines the periphery of the light beam 3. As an illustration, the first edge portion 11 of the edge 13, which is the closest portion of the edge 13 to the surface 2, determines a first peripheral portion 31 of the light beam 3 and the second edge portion 12 of the edge 13, which is the most remote portion of the edge 13 from the surface 2, determines a second peripheral portion 32 of the light beam 3.

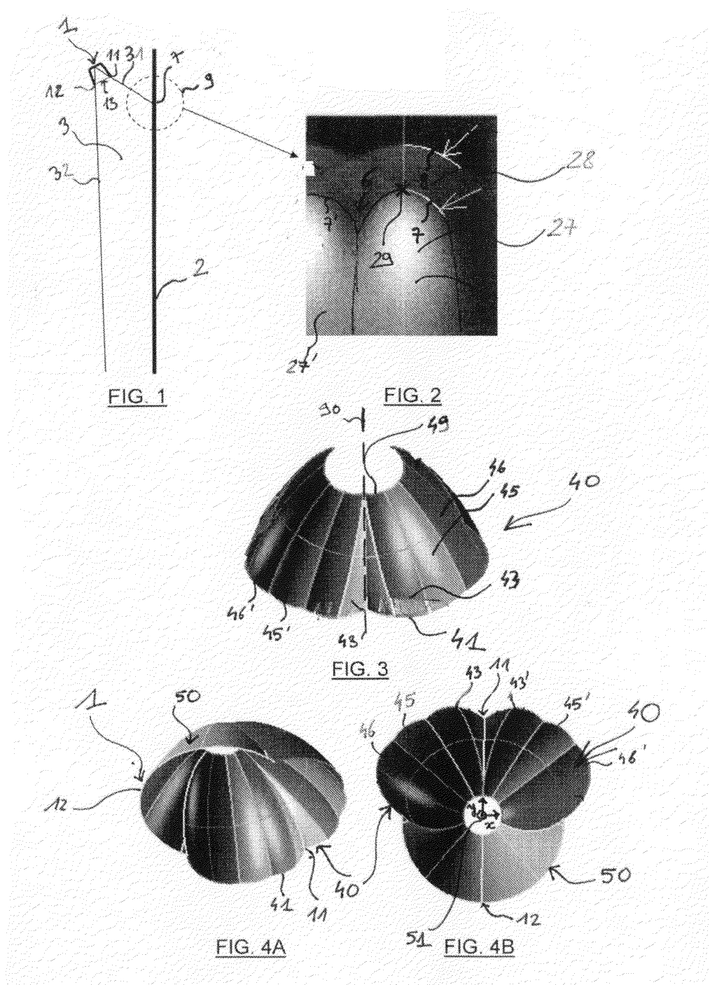

The reflective device according to prior art is typically symmetrical with respect to an axis, and is paraboloid or hemispherical or conical. The projection of the light beam 3 emitted by such a known obliquely oriented reflective device with the surface 2, illuminates a main area 27 of the surface 2 as shown in FIG. 2 (it is to be noticed that this simulation was performed from two luminaires 1 positioned side-by-side; illuminating therefore two main areas 27 and 27′). At the top part 9 of the surface 2, the main area 27 is limited by a curve 7 corresponding to the light cut-off of the first edge portion 11, such curve 7 comprising an apex 29. Moreover, due to the light cut-off effect, a light halo 28 (i.e. which has a light intensity significantly lower than those of the main area 27) appears on top of said curve 7 until another curve 8.

The presence of this light halo 28 is usually not desirable, especially for indoor illumination.

Moreover, in case several luminaires 1 are used side-by-side, the two main areas 27-27′ are separated by a top darker zone 6 which is usually also not desirable, especially in the case it is needed to illuminate a portion of the surface 2 (or an element on the surface 2) overlapping curves 7-7′.

To solve these problems addressed by the inventor, it is hereby proposed to provide the reflective device with secondary optics 40 together with a main reflective member 50 (see FIG. 3, 4A and 4B).

The main reflective member 50 might be similar to said reflective device according to prior art. However, this main reflective member 50 may be symmetrical or asymmetrical with respect to an axis, and may be of any shape, e.g. according to a paraboloid, ellipsoid, hemispherical, conical, quadratic and/or any polynomial function. Preferably the main reflective member 50 is designed to produce a rotational beam 3. A through hole 51 may be provided at one side of the main reflective member 50 to position the light source therethrough.

The secondary optics 40 may be an accessory, as shown in FIG. 3, or may be made integrally with the main reflective member 50. A through hole 49 may be provided at one side of the secondary optics 40 to match the through hole 51 of the main reflective member 50.

In this particular embodiment of the invention, the secondary optics 40 comprises a plurality of adjacent reflective concave, elongated sectors 43-43′, 45-45′, 46-46′, symmetrically positioned, by pairs, with respect to a plane 90. These reflective sectors are limited at one side by the through hole 49 and at a second side by the edge 41.

The secondary optics 40 are located within the main reflective member 50, preferably around the first edge portion 11 of the main reflective member 50 (i.e. the portion of the edge of the main reflective member 50 which is the closest one to the surface 2), the plane of symmetry 90 including preferably the point of the first edge portion 11 which is the closest one to the surface 2.

The shape and orientation of the reflective sectors 43-43′, 45-45′, 46-46′ are chosen so as to re-orientate part of the light coming from the light source on the surface 2 to increase the illuminate surface (main surface 27) and the uniformity of the light beam 3 near the top 9 of the surface 2 by creating a more squared illuminate surface.

As depicted by FIG. 4A, 4B, 5C, 5D, the reflective sectors (43, 43′, 45, 45′, 46, 46′) are designed and arranged with respect to the main reflective member 50 so as to illuminate, according to respective secondary light beams (resp. 33, 33′, 35, 35′, 36, 36′), respective secondary areas located above said curve 7, in a determined zone.

For illustration of the light effect involved by the secondary optics according to the invention, FIG. 6A, 6B and 6C depict conceptually the light distribution obtained with a secondary optics 40 made of 8 ellipsoidal sectors (not shown), wherein these reflective sectors are designed and arranged with respect to the main reflective member 50 so as to illuminate, according to respective secondary light beams (resp. 93, 93′, 94, 94′, 95, 95′, 96, 96′), respective secondary areas (resp. 23, 23′, 24, 24′, 25, 25′, 26, 26′) located above said curve 7, in a zone extending between:

this curve 7; and

a referential line 60 located on top of the curve 7 (i.e. this referential line 60 does not cross said main area 27) or at a certain distance above the apex 90 of the curve 7. In a particular case, the referential line 60 is parallel to the line tangent to the curve 7 at the apex 90 or the referential line 60 is tangent to the curve 7 at the apex 90. By illuminating this zone with new secondary beams (33, 33′, 35, 35′, 36, 36′; or 93, 93′, 94, 94′, 95, 95′, 96, 96′), the top part of the surface 2 is illuminated according to an illuminated area 27″ which is more squared (i.e. reduced dark zone 6) or flattened, has a limited light halo (28) and a broader illuminated band, as shown in FIG. 8. Uniformity of light in this zone may further be optimized by arranging the reflective sectors to generate overlapping of neighbored secondary areas (23, 23′, 24, 24′, 25, 25′, 26, 26′) on the surface 2.

In a specific case, the reflective sectors (43, 43′, 45, 45′, 46, 46′) are oriented according to respective secondary axes (resp. 33, 33′, 35, 35′, 36, 36′) comprising the center of the light source and oriented to the corresponding secondary area to illuminate. In that case the reflective sectors (or secondary reflective elements) are elongated along their respective axes to avoid as much as possible back reflections to the light source, and to accompany their respective secondary light beams to the respective secondary areas.

In a particular case these reflective sectors (43, 43′, 45, 45′, 46, 46′) are ellipsoidal, i.e. made from ellipsoids. Especially, these ellipsoids may be ellipsoids of revolution around the secondary axes, constructed from respective ellipses having their respective first and second foci both located on the respective secondary axes (resp. 33, 33′, 35, 35′, 36, 36′), in particular by placing the first focus at the light source, in order to optimize the light guiding of the secondary beams from the light source to the surface 2 without significant reflections.

The eccentricity of each ellipsoid and number of ellipsoids are linked to the uniformity needed on the surface 2 to be illuminated. In other words, eccentricity and number of ellipsoids depend on the importance (surface) of “black holes” over said zone (between curve 7 and referential line 60) of the surface 2 to be filled and the zone location.

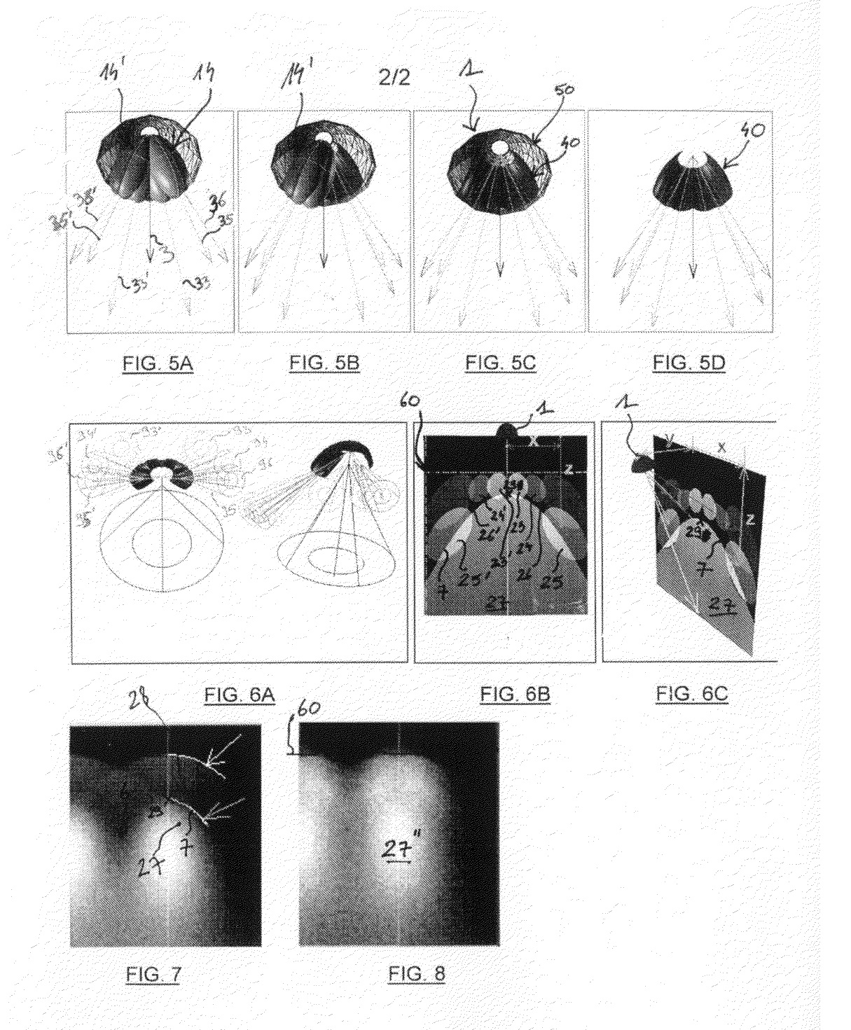

FIG. 5A-5D depict exemplary steps of a method of designing secondary optics according to the invention. First, light source and main reflective member are positioned so as to illuminate a main area of the surface 2 (not shown). Then the designer chooses the number, positions and sizes of the secondary areas that he wants to illuminate on the surface 2 by using the secondary optics 40, these secondary areas being located between the curve 7 of the main area 27 and the referential line 60. As shown in FIG. 5A, secondary axes 33, 33′, 35, 35′, 36, 36′ are then found by joining the center of the secondary areas (in this specific case, there is 6 secondary areas to illuminate) and the center of the light source. Ellipsoids 14′, of revolution with respect to these secondary axes, are then constructed from a referential ellipse whose foci are positioned on their respective secondary axes 33, 33′, 35, 35′, 36, 36′. As aforementioned, the positions and nature of the ellipses are chosen by the person skill in the art to find an acceptable lighting results with a minimum of ellipsoids. As shown on FIG. 5B, the portions of the external surfaces of the ellipsoids which face the inner surface of the main reflective member 50 are the inner surfaces of the secondary optics which define therefore ellipsoidal concave surfaces. The inner surfaces of the secondary optics are further cut according to a cutting function (e.g. an ellipsoidal or ellipse or a circular or a plane function) as aforementioned.

One example of an optical system comprising two luminaires 1 placed side-by-side:
two orthogonal (x,y,z) references are used to position the elements of the system, having both x-axis and z-axis parallel to the surface 2, and the z-axis included in the plane of symmetry 90, both references further having y-axis perpendicular to the surface 2 and having their respective origins (0,0,0) located at the light sources of respective luminaires 1;
Light sources of the luminaires 1 are positioned from the surface 2 by a distance Y₀=0.8 meter;
The main reflective member 50 is an ellipsoidal sector, the ellipsoid is an ellipsoid of revolution being defined from the following ellipse:

First focus X=0, Y=0, Z=0 mm

Second focus X=0, Y=0, Z=280 mm

Point on ellipsoid X=56.5, Y=0, Z=49.2 mm

Eccentricity=0.895902

Furthermore, this ellipsoid is cut by a plane perpendicular to the z-axis and located at z=49.2 mm from the first focus, creating therefore the edges 13 of the luminaires.

The luminaires 1 are then rotated around their light sources (0,0,0) so as finally to point to the bottom part of the surface 2 and be tilted by an angle of about −166 degrees;

The distance between the two luminaires 1 is of 1.2 meter approximately.

The secondary optics 40 is constructed from a boolean union of 6 ellipsoids, respectively constructed by 6 rotations (see below the definition of the six rotations) of a referential ellipsoid, the referential ellipsoid being of revolution and constructed from the following ellipse:

First focus X=0, Y=0, Z=0 mm;

Second focus X=0, Y=0, Z=80 mm;

Point on ellipsoid X=0, Y=9.6, Z=0 mm;

Eccentricity=0.887174.

The rotation of this referential ellipsoid for defining said 6 ellipsoids is performed around the first focus:

1^{st} ellipsoid 46:
rotation in direction X=−84, Y=66, Z=150 mm;

2^{nd} Ellipsoid 46′:
rotation in direction X=84, Y=66, Z=150 mm;

3^{rd} Ellipsoid 45:
rotation in direction X=−76.5, Y=93.5, Z=165 mm;

4^{th} Ellipsoid 45′:
rotation in direction X=76.5, Y=93.5, Z=165 mm;

5^{th} Ellipsoid 43:
rotation in direction X=−44, Y=121, Z=180 mm;

6^{th} Ellipsoid 43′:
rotation in direction X=44, Y=121, Z=180 mm.

The Boolean union of the 6 previous ellipsoids:

Make the ellipsoids cut at the intersection with the neighbored ellipsoids, for having finally concave ellipsoidal sectors; and

are further cut, according to the edge 41 (FIG. 3), by another ellipsoid (“cut ellipsoid”) of revolution defined by:

First focus X=0, Y=0, Z=0 mm;

Second focus X=0, Y=0, Z=400 mm;

Point on ellipsoid X=0, Y=12.8, Z=0 mm;

Eccentricity=0.968512;

this “cut ellipsoid” is also cut by two horizontal planes at Z=48.24 mm, and Z=0 mm. Then the secondary optics 40 is positioned within the main reflective member 50, at the first edge portion 1.

While the invention has been illustrated and described in detail in the drawings and foregoing description, such illustration and description are to be considered illustrative or exemplary and not restrictive; the invention is not limited to the disclosed embodiments, and the person skilled in the art can clearly adapt the teaching of the invention, especially relating to the number and dispositions of the secondary reflective elements. For example, the number of secondary reflective elements are not limited to 6 or 8, but can be more or less, odd or even. The person skilled in the art might for instance decide to provide the secondary optics with only three ellipsoidal sectors, because there is no need to add more ellipsoidal sectors for the desired lighting uniformity. Furthermore, these secondary reflective elements are not necessarily ellipsoidal, but might also have other shapes (a portions of cylinders, of cones, or may be calculated from polynomial functions). The invention covers also any optical system made of a plurality of luminaires according to the invention, especially optical systems comprising an array or matrix of such luminaires placed side-by-side, in order to obtain large bands of light on the surface to illuminate.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

1. A luminaire arranged to illuminate a surface, the luminaire comprising:
alight source emitting light rays that are obliquely oriented with respect to the surface, and
a reflective device comprising:
a main reflective member arranged to redirect the light rays, according to a primary light beam, for illuminating a main area of the surface, the main area being limited by a curve having an apex, and
secondary concave reflective elements designed and arranged with respect to the main reflective member so as to illuminate, according to respective secondary light beams, respective secondary areas located between the curve and a referential line, the referential line being located on the surface at a determined distance from the apex of the curve, not crossing the curve.

2. The luminaire of claim 1, wherein the referential line is parallel to a line tangential to the apex.

3. The luminaire of claim 1, wherein the secondary reflective elements are arranged together to form a reflective assembly being symmetrical with respect to a plane.

4. The luminaire of claim 1, wherein the secondary reflective elements are adjacent reflective sectors.

5. The luminaire of claim 1, wherein the secondary reflective elements are reflective sectors cut at opposite edges according to a cutting function.

6. The luminaire of claim 1, wherein at least one of the secondary concave reflective elements is oriented according to a secondary axis which comprises the center of the light source and points to the corresponding secondary area.

7. The luminaire according to claim 1, wherein the shape of at least one of the secondary concave reflective elements is an ellipsoidal sector.

8. The luminaire according to claim 1, wherein at least one of the ellipsoidal sectors is oriented according to a secondary axis, and wherein the first focus and the second focus of the ellipsoid are located on the secondary axis.

9. The luminaire of claim 7, wherein the secondary concave reflective elements comprise at least two adjacent ellipsoid sectors arranged together to form a reflective assembly being symmetrical with respect to a plane.

10. The luminaire according to claim 1, wherein the secondary concave reflective elements form an integral accessory positioned or fixed inside the main reflective member.

11. The luminaire according to claim 1, wherein the secondary concave reflective elements are integrally formed with the main reflective member.

12. The luminaire according to claim 1, wherein the secondary concave reflective elements are located on the side of the reflective device which is the closest to the surface to illuminate when the luminaire is obliquely positioned with respect to the surface.

13. The luminaire according to claim 1, wherein the secondary concave reflective elements are designed and oriented to illuminate respective secondary areas so as to flatten said curve of the illuminated main area, as a result of the presence of said secondary areas.

14. Optical accessory arranged to be fixed or positioned within a main reflective member of a luminaire comprising a light source for emitting light rays that are obliquely oriented with respect to a surface to be illuminated, said main reflective member being arranged to redirect the light rays emitted by the light source according to a primary light beam for illuminating a main area of the surface the main area being limited by a curve having an apex, wherein the optical accessory comprises secondary reflective elements designed and oriented to illuminate, according to respective secondary light beams, respective secondary areas located between the curve and a referential line, the referential line being located on the surface at a determined distance from the apex of the curve, not crossing the curve.

15. Optical accessory according to claim 14, wherein said secondary reflective elements comprise ellipsoidal sectors.
